(19) United States
(12) Patent Application Publication
(10) Pub. No.: US 2026/0077307 A1
(43) Pub. Date: Mar. 19, 2026

(54) CARBON CAPTURE APPARATUS AND METHOD OF MANUFACTURE

(71) Applicant: Roderick Edward Enoch, II, Little Ferry, NJ (US)

(72) Inventor: Roderick Edward Enoch, II, Little Ferry, NJ (US)

(21) Appl. No.: 19/203,470

(22) Filed: May 9, 2025

Related U.S. Application Data
(60) Provisional application No. 63/695,922, filed on Sep. 18, 2024.

(51) Int. Cl. B01D 53/62; B01D 53/82

(52) U.S. Cl. CPC B01D 53/62; B01D 53/82; B01D 2251/304; B01D 2251/306; B01D 2251/404; B01D 2251/604; B01D 2251/606; B01D 2257/504

(57) ABSTRACT

The present disclosure pertains to an environmental technology apparatus designed for carbon capture and reduction of greenhouse gases. The solution involves a cleaning apparatus comprising a fibrous body infused with a binding agent and a carbon capture agent, such as Potassium Carbonate (K₂CO₃), Calcium Hydroxide (Ca(OH)₂), or Sodium Carbonate (Na₂CO₃). The apparatus features multiple layers, including an outer absorbent layer and an inner layer infused with the carbon capture agent, enhancing the environmental profile by actively reducing CO2 emissions. The primary use of this apparatus is in cleaning applications, with potential extensions to air filters, personal protective equipment, and other fibrous materials. The method of manufacture involves creating a homogeneous carbon capture mixture and integrating the mixture with substrates like paper pulp or sustainable fibrous alternatives such as bamboo and hemp, forming a functional cleaning apparatus ready for carbon dioxide capture.

### CROSS-REFERENCE TO RELATED APPLICATIONS

This application claims benefit to Provisional Application No. 63/695,922, filed Sep. 18, 2024, the contents of which are herein incorporated by reference.

### BACKGROUND OF THE INVENTION

### Field of Endeavor

The present disclosure pertains to environmental technologies, specifically focusing on cleaning apparatuses designed for carbon capture and the reduction of greenhouse gases.

### Background of Related Art

Cleaning tools and related materials have played a significant role in domestic and commercial hygiene practices for many years. Traditionally, these articles have been developed primarily for their cleaning and sanitization functions, with design considerations focused on performance, durability, and user comfort. Over time, however, increasing attention has been paid to the broader environmental implications associated with such products, including issues of waste generation and the environmental footprint of their manufacturing, use, and disposal. In today's market, there is a growing recognition that cleaning tools can contribute not only to immediate hygienic needs but also promote a more sustainable approach, thus ensuring a better balance between functionality and environmental responsibility.

There is a rising interest among consumers and manufacturers alike in cleaning products that serve multiple useful functions while aligning with increasingly stringent environmental standards. Efforts to improve the ecological profile of these products involve exploring economically viable and environmentally friendly methods to reduce waste and minimize the presence of undesirable chemicals. The goal is to integrate additional functional properties that extend beyond conventional cleaning performance and enhance the overall sustainability of the product without compromising the primary utility of the cleaning products. Such pursuits are driven by evolving market demands and regulatory pressures to adopt greener practices in product development.

Despite ongoing innovations, many existing cleaning items still rely on materials and formulations that, while effective for cleaning, contribute to broader environmental challenges. Common cleaning products often incorporate elements that are not readily biodegradable or that may contain aggressive chemicals, leading to increased concerns about their long-term impact on environmental health. Moreover, the conventional focus on single-function performance tends to overlook opportunities to imbue everyday products with additional environmental benefits. This dichotomy underscores the challenge of reconciling traditional cleaning efficacy with the need for ecological compatibility.

There remains a clear need for advancements that harmonize robust cleaning performance with environmentally oriented features. Current solutions often fall short by addressing either the direct functional requirements of cleaning or the wider environmental considerations, rather than uniting these aspects in a single product design. Bridging this gap is necessary to satisfy modern market expectations and regulatory objectives, which increasingly demand that products not only perform their conventional roles but also contribute to environmental sustainability. Addressing such a need would pave the way for innovative cleaning materials that better align with the dual goals of effective sanitation and enhanced ecological stewardship.

### SUMMARY OF THE INVENTION

In one embodiment, a cleaning apparatus is disclosed. The cleaning apparatus comprises a body formed from a fibrous material that is infused with both a binding agent and a carbon capture agent. In some embodiments, the carbon capture agent is present in an amount of 1-5% by weight relative to the fibrous material and is selected from potassium carbonate (K₂CO₃), calcium hydroxide (Ca(OH)₂), or sodium carbonate (Na₂CO₃). The binding agent may be selected from starch, cellulose derivatives, natural latex, alginates, or polyvinyl alcohol. In certain embodiments, the fibrous body is additionally infused with one or more cleaning, sanitization, or antimicrobial agents, and the fibrous material may be treated with enzymes such as bromelain or xylanase. The carbon capture agent can also be combined with functionalized silica nanoparticles, which in some cases are treated with an organosilane, and the apparatus may further include a humectant configured to maintain ambient moisture and optimize carbon dioxide capture efficiency.

In another embodiment, a method of manufacturing a carbon capture cleaning apparatus is disclosed. The method comprises preparing a carbon capture solution by dissolving a carbon capture agent in a solvent and preparing a binding agent solution by dissolving a binding agent in a solvent. These solutions are then combined to form a homogeneous carbon capture mixture, which is integrated with a fibrous substrate to form a composite pulp mixture wherein the carbon capture agent is present in an amount of approximately 1-5% by weight relative to the fibrous substrate. The composite mixture is formed into at least one sheet and dried to produce the cleaning apparatus configured to capture carbon dioxide from the ambient environment. In some embodiments, the carbon capture agent is chosen from potassium carbonate (K₂CO₃), calcium hydroxide (Ca(OH)₂), or sodium carbonate (Na₂CO₃). Additional steps may include adding one or more enzymes to the fibrous substrate prior to integration and incorporating one or more components selected from a humectant for moisture prevention and flexibility, an activated carbon powder, or functionalized silica nanoparticles, with the binding agent being selected from starch, cellulose derivatives, natural latex, alginates, or polyvinyl alcohol.

### BRIEF DESCRIPTION OF THE DRAWINGS

FIG. 1 is a flowchart of an embodiment of a method of manufacturing a carbon capture cleaning apparatus, according to aspects of the present invention;

FIG. 2 is a diagram of an embodiment of a cleaning apparatus, according to aspects of the present invention;

FIG. 3 illustrates the comparative performance of the carbon capture apparatus of the present invention with selective nanoparticle-embedded material versus conventional alkaline sorbents under high humidity conditions; and

FIG. 4 is a schematic diagram depicting ionic bonding between alkaline nanoparticles and the cellulose-based fiber substrate.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The current technological development addresses the pressing issue of climate change and environmental degradation, which are becoming increasingly important considerations in the design and manufacture of consumer products. Traditional household cleaning items, such as paper towels and cleaning fabrics, contribute to environmental challenges by adding to landfill waste without offering any positive impact on climate change. These products often contain harsh chemicals and lack biodegradability, further exacerbating their negative environmental footprint. As a result, there is a growing need for new solutions that not only fulfill their primary cleaning functions but also contribute positively to environmental sustainability.

Existing cleaning products in the market are primarily designed for their cleaning and sanitization capabilities, with little regard for their environmental impact. Many of these products rely on materials and formulations that are not readily biodegradable and may contain aggressive chemicals, raising concerns about their long-term effects on environmental health. Furthermore, the conventional focus on single-function performance overlooks opportunities to integrate additional environmental benefits into everyday products. This gap highlights the challenge of reconciling effective cleaning performance with ecological compatibility, a balance that is increasingly demanded by consumers and regulatory bodies alike.

The present disclosure provides a novel cleaning apparatus that addresses these challenges by integrating carbon capture capabilities into a traditional cleaning product. This apparatus comprises a cleaning fabric, such as a paper towel or other fibrous material, infused with chemical compounds specifically configured to capture carbon dioxide (CO₂) from the ambient environment. The cleaning apparatus is designed with multiple layers, each serving a distinct function, including an outer absorbent layer, an inner layer infused with a carbon capture agent, and an optional structural integrity layer. This innovative approach not only maintains the primary utility of the cleaning product but also enhances the environmental profile by actively reducing greenhouse gases. The apparatus leverages sustainable materials and processes to ensure that the product is both effective in its cleaning function and beneficial in its environmental impact.

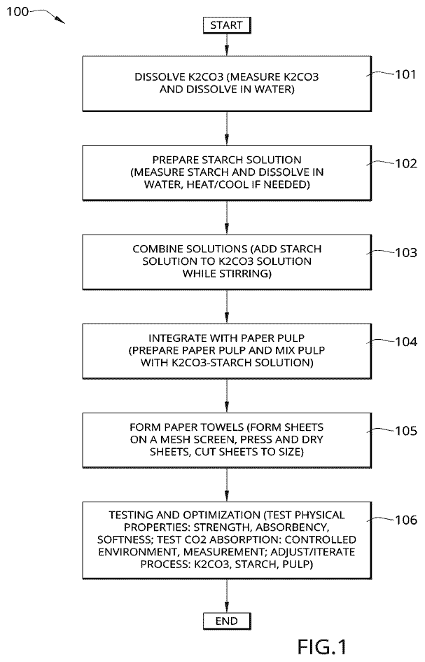

FIG. 1 illustrates a method 100 for producing a carbon capture cleaning apparatus 200. Briefly, and described in more detail hereinafter, one or more compounds are applied to a substrate, such as pulp, to produce the carbon capture cleaning apparatus 200. Unless otherwise specified, all volume-based measurements (e.g., hydrogen peroxide in bleaching solution) are expressed as volume-to-volume (v/v), or weight-to-weight (w/w) relative to the total substrate, i.e. pulp, liquid content during the mixing stage.

The method 100 starts with step 101, where a compound, as a carbon capture agent, is dissolved to form a carbon capture solution. In embodiments, the carbon capture agent as Potassium Carbonate (K₂CO₃) is measured and is dissolved in water to form a K₂CO₃ solution, i.e. the carbon capture solution. In an exemplary embodiment, 30 grams of K₂CO₃ are provided as a solute per liter of water as a solvent. In alternative embodiments, the carbon capture agent can be one of: Calcium Hydroxide (Ca(OH)₂), or Sodium Carbonate (Na₂CO₃). Preferably, the carbon capture solution is 1-5% by weight of the substrate.

In embodiments, the carbon capture agent, such as K₂CO₃ functions to remove CO2 from the environment utilizing the following reaction: K₂CO₃+CO₂+H₂0 2KHCO₃. As described by the equation, K₂CO₃ captures CO₂ by utilizing water in the ambient environment to convert K₂CO₃ to Potassium Bicarbonate KHCO3. In alternative embodiments, Calcium Hydroxide may react with CO₂ to form calcium carbonate (CaCO₃), a stable, non-toxic compound.

In embodiments, the CO₂ capture efficiency of the cleaning apparatus can be enhanced when the carbon capture cleaning apparatus 200 is dampened. Moisture, either from cleaning surfaces or ambient humidity, activates the reaction between K₂CO₃ and CO₂, making the process more effective. In embodiments, moisture-absorbing components, such as silica gel micro-beads, may be incorporated to improve performance in dry environments. Advantageously, Silica gel micro-beads help maintain ambient moisture, which is crucial for chemical CO₂ capture.

In step 102, a binding agent solution is prepared. In a first embodiment, the binding agent is starch, but is not so limited, as binding agents such as cellulose derivatives, natural latex, alginates, or polyvinyl alcohol are also contemplated. The binding agent solution is prepared by measuring the binding agent, such as starch, and dissolving the binding agent in water. In an exemplary embodiment, 10 grams of starch is provided as a solute per liter of water as a solvent. In embodiments, the binding agent solution requires heating or cooling to achieve the desired consistency. Preferably the binding agent is approximately 0.5-2% by weight of the substrate. Advantageously, the binding agent ensures the stability and distribution of the carbon capture compound within the cleaning apparatus 200.

Additional binding agents can be infused into the cleaning apparatus, in addition to starch. In embodiments, these additional agents can be selected from agents having desirable properties such as, biodegradability and eco-friendliness, and can enhance the structural integrity of the cleaning apparatus without impairing the carbon capture process. In embodiments, these additional agents can be segregated into natural agents, and synthetic agents, wherein the natural agents can include cellulose derivatives (e.g., carboxymethyl cellulose), natural latex, alginate from algae, etc. Additionally, synthetic agents can share the desirable properties of natural agents and can include, Polyvinyl Alcohol (PVA), but may vary depending on manufacturing needs and environmental conditions, and are preferably approximately 0.5-2% by weight of the substrate.

In Step 103, the carbon capture solution and the binding agent solution are combined, while stirring, to form a homogeneous carbon capture mixture. The homogeneous carbon capture mixture integrates the binding solution and carbon capture solution, forming a stable matrix for the subsequent integration with the substrate, such as paper pulp, recycled paper, cardboard, nonwoven fabric, cotton blends, air filters, tissue, toilet paper, and packaging materials.

Step 104 describes the integration of the homogeneous carbon capture mixture with the substrate. In embodiments, the substrate can be derived from traditional paper pulp or alternative fibrous sources such as bamboo, bagasse, hemp, kenaf, or agricultural waste fibers. These materials may offer improved biodegradability, tensile strength, or environmental performance. The homogeneous mixture can be applied to these substrates, and the homogeneous mixture can be mixed, or applied to the paper pulp, to form a homogeneous carbon capture pulp mixture. In some embodiments, the fibrous substrate may include silica-functionalized cellulose particles, wherein silica (SiO₂) is chemically bonded to the cellulose structure through surface treatment or silanization. These particles may comprise at least 5% SiO₂ by weight relative to the total weight of the modified fibrous component. Such silica-functionalized fibers can provide enhanced structural stability and contribute to the CO₂ adsorption mechanism by supporting ionic or hydrogen bonding interactions with carbon capture agents.

In embodiments, paper pulp can be prepared using approximately 1000 grams of recycled paper sheets, cut into small pieces and immersed in water in a ratio of 4:1 (4 liters of water) in a container and left to soak for a period of time, such as 12 hours. The soaked paper is transferred to a blender and blended until a uniform pulp consistency is achieved.

In embodiments, prior to step 104 one or more chemical compounds are, optionally, added to the substrate, i.e. paper pulp, in the manufacture of the cleaning apparatus 200. In embodiments, the one or more chemical compounds can include at least one of: a cleaning agent, a sanitization agent, an antimicrobial agent, a binding agent, and a stabilization agent. In embodiments, cleaning agents, sanitization agents, and/or antimicrobial agents can be any agent known in the art configured to perform the function. For example, cleaning agents can be any known agent configured to clean surfaces, sanitization agents can be any known agent configured to sanitize or disinfect surfaces, and antimicrobial agents can be any known agent configured to destroy, reduce, or prevent buildup of bacteria. Importantly, agents must be chosen such that they do not interfere or otherwise degrade binding agents, stabilization agents, and carbon capture agents. For example, antimicrobial agents may include bleach (sodium hypochlorite), silver nanoparticles, or quaternary ammonium compounds; sanitization agents may include hydrogen peroxide or isopropyl alcohol; and cleaning agents may include surfactants such as sodium lauryl sulfate. In embodiments, the one or more chemical compounds are added preferably 1-5% w/w relative to the substrate. In some embodiments, a portion of the substrate may be treated with one or more hydrophobic coatings or agents to improve water resistance or control directional moisture flow.

Additionally, and optionally, amounts of Bromelain (0.2% w/w with respect to the substrate) and Xylanases solution (50 mL per kg of substrate) can be added to the substrate as process-enhancing enzymes prior to optional bleaching and/or integration of the homogeneous carbon capture mixture with the one or more substrates. These enzymes are, optionally, added in low concentrations (e.g., 0.05-0.2% w/w relative to the substrate) and allowed to react for 1-3 hours at moderate temperatures (˜35-50° C.). Following enzyme treatment, the substrate may be optionally bleached with hydrogen peroxide, described further hereinafter, then infused with the carbon capture mixture, at Step 104. Advantageously, Xylanases facilitate breakdown of hemicellulose in paper fibers, increasing porosity and improving the uniformity of bleaching. Advantageously, Bromelain, a proteolytic enzyme derived from pineapple waste, aids in softening the pulp and enhancing fiber separation, making the substrate more receptive to additives like potassium carbonate.

Optionally, prior to the integration of the homogeneous carbon capture mixture with the substrate, at step 104, the substrate can be bleached using hydrogen peroxide, (H₂O₂) and the homogeneous carbon capture mixture can be added. An exemplary concentration is 1-5% v/v H₂O₂ relative to the substrate, i.e. pulp, mixed and maintained at room temperature or slightly elevated temperatures (30-50° C.) for 1-2 hours to achieve decolorization. Bleaching is followed by neutralization (e.g., with sodium carbonate) and thorough rinsing before proceeding to final additive integration in Step 104.

Subsequent to integration of the homogeneous carbon capture mixture with the substrate in step 104, an amount of Glycerin can be added to the homogeneous carbon capture pulp mixture, such as 10 ml (1% W/V), as a humectant for moisture preservation and flexibility. In some embodiments, an additional additive such as activated carbon powder, and/or functionalize silica nano-particles (described further hereinafter) are incorporated into the homogeneous carbon capture pulp mixture, at this stage, for example, at 1%-5% by weight (w/w) relative to the homogeneous carbon capture pulp mixture for improved CO2 absorption. In some embodiments, silica gel microbeads may also be added during this stage at a concentration of 1-3% w/w to enhance localized moisture retention within the Carbon Capture Layer 220. These microbeads may be dispersed uniformly throughout the pulp matrix alongside potassium carbonate and functionalized nanoparticles, and become part of the carbon capture layer formed in step 105. Advantageously, mixing in this manner ensures that the homogeneous carbon capture mixture is evenly distributed throughout the pulp, which is necessary for the effective functionality of the cleaning apparatus 200.

In step 105, the cleaning apparatus is formed by spreading the homogeneous carbon capture pulp mixture onto a forming apparatus, such as a mesh screen, to form one or more sheets. The one or more sheets are pressed and dried, and cut into sheets of one or more desired sizes. In embodiments, the one or more sheets, after pressing and drying can be layered to form a layered cleaning apparatus having added structural, absorptive, and reactive qualities. This step transforms the homogeneous carbon capture pulp mixture into a functional cleaning apparatus, ready for use in capturing carbon dioxide. Optionally, the cleaning apparatus is formed as a multilayer structure, by spreading the homogeneous carbon capture pulp mixture between at least two outer fibrous sheets. The outer sheets are configured to provide absorbency. Additionally, an inner backing layer can be provided between the outer sheets with the homogeneous carbon capture pulp mixture, and is configured to add structural support. The layers are laminated together and dried, forming a composite towel with a defined middle carbon-capturing layer.

In an alternative embodiment, the cleaning apparatus is form using additive manufacturing, such as 3D printing, by extruding the homogeneous carbon capture pulp mixture into one or more layers, layer-by-layer into a defined geometry. Advantageously, this permits tunable porosity and controlled layering, particularly useful for air filters and structured formats beyond standard paper rolls.

In step 106 testing and optimization can be performed. The physical properties of the paper towels, such as strength, absorbency, and softness, are tested alongside their CO₂ absorption capabilities in a controlled environment. Based on these tests, adjustments and iterations are made to the process, optimizing the concentrations of the carbon capture agent, the binding agent, one or more additional compounds, and/or the substrate to enhance the performance of the cleaning apparatus.

In embodiments, optimization of the carbon capture cleaning apparatus 200 includes impregnation of the carbon capture cleaning apparatus 200 with improved Silicon Dioxide (SiO₂) nanoparticles.

SiO₂ nanoparticles are synthesized utilizing a process having one or more components such as Deionized Water, Anhydrous Ethanol, Ammonium Hydroxide, and/or Tetraethyl orthosilicate (TEOS). In an exemplary embodiment, the process of synthesizing SiO₂ begins by mixing, in a centrifuge, an amount of deionized water and anhydrous ethanol for a period of time, such as 10 minutes, at approximately 400 revolutions per minute (RPM). In embodiments, a silica nanoparticle solution is prepared by combining approximately 25% deionized water, 60% anhydrous ethanol, and 10% ammonium hydroxide (28%). To this, 2.5% TEOS is added dropwise under stirring to initiate sol-gel formation of silicon dioxide nanoparticles. These percentages are approximate and may be adjusted based on the desired nanoparticle size or concentration. Unless otherwise specified, all percentage concentrations are expressed as weight percent (w/w) relative to the dry fibrous substrate.

Once centrifuging is completed an amount of ammonium hydroxide is added to the solution and the new solution is centrifuged for a period of time, such as 10 min at 450 rpm. In the exemplary embodiment, the amount of ammonium hydroxide is 6 ml. Once centrifuging of the ammonium hydroxide is completed an amount of TEOS is added and the solution is centrifuged for a period of time, such as 60 minutes, at 800 rpm. In the exemplary embodiment, the amount of TEOS is 1.5 ml.

Once centrifuging of TEOS is completed, and a change of color of the new solution is observed, indicating formation of SiO₂ nanoparticles, the solution is centrifuged at 10,000 rpm for a period of time, such as 10 minutes, to separate the nanoparticles from the solution. In embodiments, after each centrifugation step one or more purification step(s) can occur wherein the supernatant liquid is decanted and replaced with fresh deionized water to clean the nanoparticles. In embodiments, purification is repeated as necessary to remove residual reactants or byproducts.

Once SiO₂ nanoparticles are separated, they need to be calcined, for which they are dried for 2 hours at 600° C. Finally, the nanoparticles obtained are pulverized in a mortar until a fine powder is obtained.

In embodiments, Silane functional groups are added to SiO₂ nanoparticles, to form improved nanoparticles, for improved CO₂ capture. In addition to the SiO₂ nanoparticles, components such as Anhydrous ethanol, and/or 3-Aminopropyltriethoxysilane (APTES), are utilized.

The process of creating improved SiO₂ nanoparticles begins by adding SiO₂ nanoparticles in anhydrous ethanol in a ratio of 1:10, i.e. 10 grams of nanoparticles in 100 ml of ethanol, to form a SiO₂ suspension. In a separate container, APTES is dissolved in ethanol at a ratio of 1:100, in a specific embodiment 5 grams of APTES is dissolved in 500 ml of ethanol to form a silane solution. Advantageously, to increase the number of silane groups in the nanoparticles, APTES is used in a ratio of 1:2 with the SiO₂ nanoparticles.

In embodiments, the silane solution is added to the SiO₂ suspension while stirring continuously. Next, deionized water in a ratio of 1:1 with respect to APTES is added to the combined silane solution and SiO₂ suspension. In an exemplary embodiment, 5 ml of deionized water is utilized. Once the deionized water is added a reaction is allowed to take place under stirring for a time period, such as 24 hours, at given temperature, such as room temperature. Advantageously, the reaction allows the silane to adhere to the surface of the SiO₂ nanoparticles forming functionalized SiO₂ nanoparticles.

After the reaction, the functionalized SiO₂ nanoparticles are washed with ethanol to remove unreacted silane and byproducts, and the mixture is filtered to separate the nanoparticles from the solvent.

After the functionalized SiO2 nanoparticles are separated, they are dried under vacuum or at low temperature (e.g., 60° C.) to remove residual solvent and ensure that the silane functional groups are firmly anchored to the nanoparticle surfaces. In some embodiments, the dried nanoparticles are redispersed in a solvent (e.g., water or isopropyl alcohol) to form working suspensions of varying concentrations, such as 3%, 5%, 7%, or 10% by weight. In these embodiments, an alternative method of impregnation is employed wherein the carbon capture cleaning apparatus 200—after formation and drying—is sprayed with the SiO2 suspension to deposit functionalized nanoparticles onto its surface. Residual binder (e.g., starch) on the substrate may aid in particle adherence, enhancing functional integration without reprocessing the entire pulp matrix

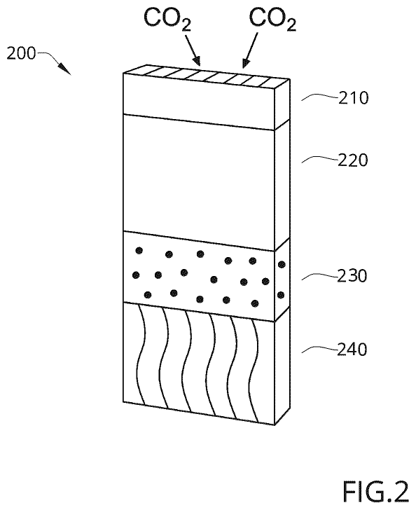

FIG. 2 illustrates a carbon capture cleaning apparatus 200, at least a portion of which is made by method 100. Briefly, and described in more detail hereinafter, carbon capture cleaning apparatus 200 can include one or more layers, such as a Moisture Barrier 210 configured to reduce humidity interference, a Carbon Capture Layer 220 configured to capture CO₂, a Starch Binder Layer 230 configured for structural cohesion, and a Fibrous Substrate Layer 240. In embodiments, one or more of the layers can be made using method 100, and can include chemicals, molecules, compounds, etc., formed thereby.

Moisture Barrier 210 is a top layer configured to prevent ambient humidity from prematurely triggering the carbon capture agent of apparatus 200, thereby preserving adsorption capacity until active use. In embodiments, Moisture Barrier 210 is formed using method 100, which may include deposition of water-resistant pulp treated with hydrophobic coatings or agents during the sheet-forming process, as outlined in method 100, as an optional step prior to step 104.

Carbon Capture Layer 220 is a functional layer adjacent to Moisture Barrier 210 containing a homogeneous dispersion of the carbon capture agent, i.e. potassium carbonate (K₂CO₃), integrated with additional layers, such as Starch Binder Layer 230 and alkaline nanoparticles 230. In embodiments, the carbon capture agent is stabilized within the starch binder ensuring adhesion to surrounding pulp fibers and structural cohesion of apparatus 200 under moisture exposure. Additionally, Alkaline Nanoparticles can be embedded within the Carbon Capture layer 220. In embodiments, Alkaline Nanoparticles 230 can include, but are not limited to amine-functionalized SiO₂ or Ca(OH)₂, as described with respect to FIG. 1, particles to enhance CO₂ capture capacity under varying humidity. In other embodiments, Ca(OH)₂ may serve directly as a carbon capture agent when used in particulate or nanoparticle form, providing both reactivity with CO₂ and structural dispersion within the layer. In some embodiments, activated carbon powder (e.g., 1-5% w/w) may also be included in the Carbon Capture Layer 220 to enhance adsorption of ambient gases and support pollutant capture. In embodiments, Carbon Capture Layer 220 and its integrated components are deposited and stabilized using steps described in method 100, including aqueous dispersion, starch-based binders, and drying stages. In embodiments, the Carbon Capture Layer 220 may further include silica gel microbeads uniformly dispersed within the pulp matrix to regulate local humidity and maintain CO₂ adsorption efficiency under varying environmental conditions.

Fibrous Substrate 240 forms the core of the cleaning apparatus 200 and is formed of biodegradable cellulose fibers derived from recycled paper, bamboo, or other sustainable fibrous inputs such as hemp or sugarcane bagasse, providing absorbency and flexibility for cleaning tasks. In embodiments, Fibrous Substrate 240 is prepared using method 100, including optional pretreatment described prior to step 104 (e.g., enzymatic softening with bromelain or xylanase), followed by mechanical integration of additives during step 104 and sheet formation in step 105. Absorbency modifiers such as glycerin or fiber porosity agents may be incorporated during substrate mixing or prior to drying.

Each of these layers cooperatively enables both cleaning performance and climate-active CO₂ removal. The starch and nanoparticle integration in the central layers creates a controlled environment for optimized CO₂ uptake during consumer use.

While described with respect to a cleaning apparatus, apparatus can be applied in one or more additional configurations. For example, the carbon capture mixture can be applied to other fibrous structures such as air filters, air scrubbers, personal protective equipment, perishable packaging, construction materials, clothing, textiles, or other fibrous or fabric materials in communicative contact with the environment.

In some embodiments, after the end-of-life phase of the cleaning apparatus, the materials remaining—including carbonate and/or bicarbonate compounds—may still retain environmentally beneficial uses. For example, potassium bicarbonate (KHCO₃) formed as a result of CO₂ capture from potassium carbonate (K₂CO₃) can be collected and used in various secondary applications:

Agricultural Fertilizer Use: KHCO₃ is recognized as a mild alkaline salt and has agricultural utility as a potassium-rich soil additive. In cases where no toxic dyes, bleaches, or antimicrobial agents are added, the leftover salts from the cleaning apparatus may be used as nutrient-rich input in farming or garden settings.

Fire Suppression Agent: KHCO₃ is used in dry chemical fire extinguishers. If captured and separated under controlled post-use systems, it may be repurposed for fire safety applications.

Cleaning and Deodorizing: KHCO₃, due to its mild alkalinity, can be used in homemade or low-impact cleaning formulations. The recycled cleaning apparatus remnants can be processed and formulated for surface cleaning or odor neutralization.

CO₂ Research or Educational Use: Used cleaning apparatuses may be harvested to demonstrate carbon capture cycles in educational or research labs.

Disposal or Composting Consideration: Although direct re-use is preferred, even if the salt concentration is too high for agriculture, the byproducts may be disposed of via regulated composting or neutralization pathways that ensure environmental safety.

In some embodiments, following active use, the cleaning apparatus 200 containing reacted carbon capture compounds (e.g., potassium bicarbonate (KHCO₃)) may be repurposed as a soil amendment. The conversion of potassium carbonate (K₂CO₃) to KHCO3 upon reaction with atmospheric CO₂ and moisture renders the cleaning apparatus environmentally benign and suitable for agricultural or horticultural reuse. The apparatus, once spent, may be shredded and composted or applied directly to soil in diluted or pelletized form. The KHCO₃ content provides mild alkalinity and potassium enrichment, making it beneficial as a soil conditioner. This post-use function supports a circular lifecycle for the product, enhancing its sustainability profile.

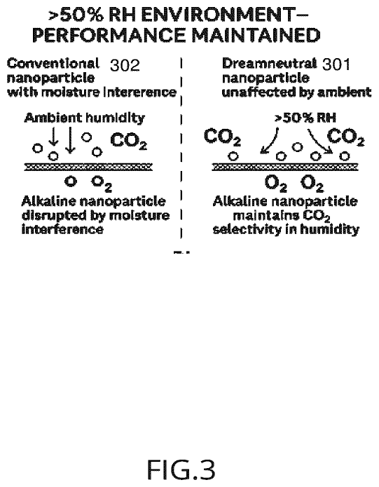

FIG. 3 illustrates the comparative performance of the carbon capture agent of the present invention, i.e. DreamNeutral's CO₂-selective nanoparticle-embedded material versus conventional alkaline sorbents under high humidity conditions. The DreamNeutral material maintains CO₂ selectivity despite moisture interference.

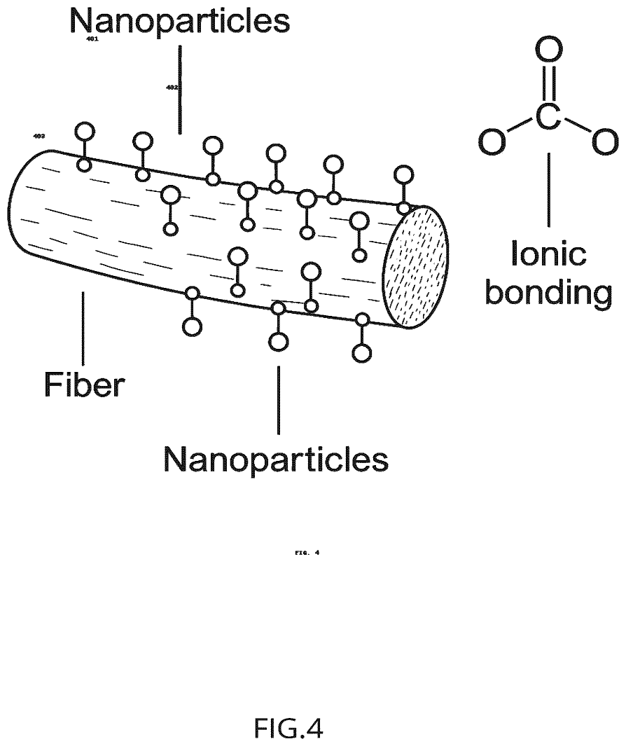

FIG. 4 is a schematic diagram depicting ionic bonding between alkaline nanoparticles and the cellulose-based fiber substrate. The visual highlights the interaction between CO₂-active agents and functional groups on the fibrous structure.

It should be understood, of course, that the foregoing relates to exemplary embodiments of the invention and that modifications may be made without departing from the spirit and scope of the invention as set forth in the following claims.

What is claimed is:

1. A cleaning apparatus, comprising:
a body formed from a fibrous material, the body infused with a binding agent, and a carbon capture agent.

2. The cleaning apparatus of claim 1, wherein the carbon capture agent is 1-5% w/w relative to the fibrous material.

3. The cleaning apparatus of claim 1, wherein the binding agent is selected from the group consisting of: starch, cellulose derivatives, natural latex, alginates, or polyvinyl alcohol.

4. The cleaning apparatus of claim 1, wherein the carbon capture agent is selected from:
Potassium Carbonate K₂CO₃, Calcium Hydroxide Ca(OH)₂, or Sodium Carbonate Na₂CO₃.

5. The cleaning apparatus of claim 1, wherein the fibrous body is infused with one or more of a cleaning agent, a sanitization agent, or an antimicrobial agent.

6. The cleaning apparatus of claim 1, wherein the fibrous material is treated with one or more of: Bromelain or Xylanase.

7. The cleaning apparatus of claim 1, wherein the carbon capture agent is combined with functionalized Silica nanoparticles.

8. The cleaning apparatus of claim 7, wherein the functionalized silica nanoparticles are treated with an Organosilane.

9. The cleaning apparatus of claim 1, further comprising a humectant configured to maintain ambient moisture and optimize CO₂ capture efficiency.

10. The cleaning apparatus of claim 1, wherein the apparatus comprises a multi-layered configuration comprising a moisture barrier layer, a carbon capture layer, a starch binder layer, a nanoparticle layer, and a fibrous substrate.

11. The cleaning apparatus of claim 10, wherein the carbon capture layer comprises potassium carbonate uniformly distributed with a starch binder, and one or more alkaline nanoparticles, wherein the one or more alkaline nanoparticles are selected from functionalized SiO₂, Calcium Hydroxide Ca(OH)₂, or Sodium Carbonate Na₂CO₃.

12. The cleaning apparatus of claim 11, wherein the starch binder is configured to protect the carbon capture agent during pulp washing and maintain distribution throughout the fibrous substrate.

13. The cleaning apparatus of claim 11, wherein the multi-layered configuration is arranged vertically in the following sequence: moisture barrier, carbon capture material, starch binder matrix, nanoparticle layer, and fibrous substrate.

14. The apparatus of claim 1, wherein the fibrous material includes silica-functionalized cellulose particles comprising at least 5% SiO₂ by weight.

15. The apparatus of claim 1, wherein the fibrous material further includes activated carbon particles in a concentration of 2-10% w/w.

16. The apparatus of claim 1, wherein the product is manufactured via an additive manufacturing or 3D printing method using layer-by-layer pulp deposition.

17. A method of manufacturing a carbon capture cleaning apparatus, comprising:
preparing a carbon capture solution by dissolving a carbon capture agent in a solvent;
preparing a binding agent solution by dissolving a binding agent selected from the group consisting of starch, cellulose derivatives, natural latex, alginates, and polyvinyl alcohol in a solvent;
combining the carbon capture solution and the binding agent solution to form a homogeneous carbon capture mixture;
integrating the homogeneous carbon capture mixture with a fibrous substrate to form a composite carbon capture pulp mixture, the carbon capture agent being present in an amount of approximately 1-5% by weight relative to the fibrous substrate; and
forming the composite carbon capture pulp mixture into at least one sheet and drying the at least one sheet to produce the carbon capture cleaning apparatus, wherein the cleaning apparatus is configured to capture carbon dioxide from the ambient environment.

18. The method of claim 17, wherein the carbon capture agent is selected from the group consisting of potassium carbonate (K₂CO₃), calcium hydroxide (Ca(OH)₂), and sodium carbonate (Na₂CO₃).

19. The method of claim 17, further comprising:
prior to integrating the homogeneous carbon capture mixture with the fibrous substrate, adding one or more enzymes to the fibrous substrate.

20. The method of claim 17, further comprising:
adding one or more of a:
humectant configured for moisture prevention and flexibility to the composite carbon capture pulp mixture;
an activated carbon powder to the composite carbon capture pulp mixture; or
a plurality of functionalized silica nano-particles to the composite carbon capture pulp mixture.
